(19) United States
(12) Patent Application Publication
(10) Pub. No.: US 2007/0210931 A1
(43) Pub. Date: Sep. 13, 2007

(54) Flash Lamp For Rescue At Sea

(76) Inventor: Dong-Soo Baik, Kyunggi-do (KR)

Correspondence Address: COLEMAN SUDOL SAPONE, P.C., 714 COLORADO AVENUE, BRIDGE PORT, CT, 06605-1601, US

(21) Appl. No.: 11/547,080

(22) PCT Filed: Jul. 16, 2004
(86) PCT No.: PCT/KR04/01769

§ 371 Date: Jan. 3, 2007

(30) Foreign Application Priority Data
May 24, 2004 (KR) 10/2004-0037034

(51) Int. Cl. G08B 5/38

(52) U.S. Cl. 340/815.75

(57) ABSTRACT

The present invention relates to a flash lamp for rescue at sea that is useful for a rescue of the distressed at sea, and in particular to a flash lamp for rescue at sea that includes a flash lamp capable of emitting flashlights, a metal air battery that uses seawater as electrolyte, a circuit for connecting the flash lamp and the metal air battery, and a assembled structure that includes the flash lamp and the metal air battery.

### TECHNICAL FIELD

The present invention relates to a flash lamp for rescue at sea that is useful for rescue of the distressed at sea, and in particular to a flash lamp for rescue at sea that includes a flash lamp capable of emitting flashlights, a metal air battery that uses seawater as electrolyte, a circuit for connecting the flash lamp and the metal air battery, and an assembled structure that envelops the flash lamp and the metal air battery.

### BACKGROUND ART

An accident occurring at sea is relatively more dangerous than an accident occurring on the land. Since there are instances where not only people in disaster but also rescuer may be fatal in rescue operations, rescue operations are still very hard work. One of the problems that are now being faced by the sea rescue is to find out the distressed in a relatively wide area of sea. A personal beacon (e.g. transceiver) such as a signal generator capable of locating the distressed is provided, but it is heavy, and a special device is additionally needed to understand the signals. Therefore, using the light for informing of rescuers the location of the distressed has been performed from a long time ago. In the United Kingdom patents No. UK 491,078 and UK 669,765, there are disclosed a lamp for the distressed or a lamp that uses a signal. In the United Kingdom patent No. UK 450,355, a construction that a lamp is attached to a lifejacket is disclosed. However, the construction disclosed in UK 450,355 is heavy, and the life span of the battery is short. Furthermore the above construction is not safe from an oxidizing agent provided in the interior of the battery. Therefore, it is difficult to actually implement the above construction. In addition, since the body of the above construction is a hard body that is formed of plastic or metal, the construction may damage lifejacket and may cause damage to the distressed or rescuers when the above construction is attached to a human body. And according to the U.S. Pat. No. 5,286,578 invented by Rao, a collapsible metal fuel battery is disclosed. The collapsible metal fuel battery by Rao comprises; a window is formed in a soft plastic pocket, and an air cathode is attached using an adhesive for thereby blocking the window. In Rao's method by an adhesive force, the battery is mechanically weak so that it may not be fitted in the environment such as at sea.

### DISCLOSURE OF INVENTION

Accordingly, it is an object of the present invention to provide a flash lamp for rescue at sea capable of overcoming the problems encountered in the conventional art.

It is another object of the present invention to provide a flash lamp for rescue at sea capable of quickly informing the location of the distressed to rescuers using a flash lamp, thus rescuing the distressed.

It is another object of the present invention to provide a flash lamp for rescue at sea capable of achieving a mechanically strong flash lamp for rescue at sea that does not cause any damage to human bodies.

It is further another object of the present invention to provide a flash lamp for rescue at sea capable of minimizing the loading space and storing area and achieving a long life span.

To achieve the above objects, there is provided a flash lamp for rescue at sea, comprising a flash lamp capable of emitting flashlights; a metal air battery that uses seawater as an electrolyte; a circuit that connects the flash lamp and the metal air battery; and an assembled structure that protects the flash lamp and the metal air battery.

The flash lamp emits flashlights using a capacitor circuit. The metal air battery comprises a metal fuel electrode inserted between two air cathode assemblies.

The air cathode assembly is fabricated in such a manner that a rubber coat is molded on a metal frame in which small holes are formed at regular intervals, and an air cathode is attached thereto. A plurality of metal air batteries is fabricated in such a manner that the left, right and lower sides of the air cathode assemblies are coupled using rubber bands. At this time, a rubber sponge is inserted between the metal air batteries. An air-permeating fluorine resin is coated on one surface of the air cathode, and carbon is coated on the other surface of the air cathode. The surface the fluorine resin-coated is attached to the metal frame. The metal fuel electrode which formed in a plate shape, is an alloy formed of major components of aluminum and magnesium. The assembled structure is constituted with two sheets of plastic films, and an opening ring is provided in the assembled structure. In the assembled structure, the portion enveloping the flash lamp therein is fully sealed by thermally adhering. In the assembled structure, the portion enveloping the metal air batteries therein are adhered using a thermal adhering or a water resistant soluble adhesive.

### BRIEF DESCRIPTION OF DRAWINGS

The preferred embodiments of the present invention will be described with reference to the accompanying drawings.

FIG. 1 is a side and front view of a flash lamp for rescue at sea according to the present invention;

FIG. 2 is a perspective view illustrating a metal frame according to the present invention;

FIG. 3 is a perspective view illustrating a metal frame with a rubber coat according to the present invention;

FIG. 4 is a state view of a first process in a fabrication process of a metal air electrode according to the present invention;

FIG. 5 is a state view of a second process in a fabrication process of a metal air electrode according to the present invention;

FIG. 6 is a state view of a third process in a fabrication process of a metal air electrode according to the present invention;

FIG. 7 is a state view of a fourth process in a fabrication process of a metal air electrode according to the present invention;

FIG. 8 is a perspective view illustrating a plurality of metal air electrodes according to the present invention;

FIG. 9 is a side view (sealed state) illustrating a construction that a flash lamp for rescue at sea is attached to a lifejacket;

FIG. 10 is a side view (opened state) illustrating a construction that a flash lamp for rescue at sea is attached to a lifejacket;

FIG. 11 is a view illustrating a flash lamp for rescue at sea is attached to a lifejacket according to the present invention; and

FIG. 12 is a view illustrating a flash lamp for rescue at sea is attached to an improved lifejacket according to the present invention.

### BEST MODE FOR CARRYING OUT THE INVENTION

The flash lamp for rescue at sea according to the present invention will be described with reference to the accompanying drawings.

The flash lamp for rescue at sea according to the present invention includes a flash lamp 10 capable of emitting flashlights, a metal air battery 20 that uses seawater as electrolyte, a circuit (not shown) connecting the flash lamp and the metal air battery, and an assembled structure 40 that envelops the flash lamp and the metal air battery.

The flash lamp 10 emits flashlights using a capacitor charging circuit. The charging operation is performed for 2 or 3 seconds, and a high voltage of above 300 volts is generated. The discharging operation is performed in a discharge tube, thus generating flashlight. The above capacitor charging circuit is well known in the art.

A transparent semi-spherical plastic cover 11 covers an upper side of the flash lamp 10 for thereby protecting the flash lamp from an external impact. The outside of the transparent semi-spherical plastic cover 11 is molded using rubber. Both the flash lamp 10 and the circuit connected with the flash lamp 10 are sealed by rubber, for thereby preventing water from leaking into the same. Both the flash lamp 10 and the circuit connected with the flash lamp 10 are provided in a circuit box 12.

The metal air battery uses zinc, magnesium, aluminum, etc. as an anode and an air electrode like oxygen electrode as a cathode. The metal air battery 20 according to the present invention uses seawater as electrolyte. In the metal air battery 20, a metal fuel electrode 22 is inserted between two air cathode assemblies 21. The air cathode assembly 21 is fabricated in such a manner that a rubber coat 24 is molded on the metal frame 23, and an air cathode 25 is attached thereto. Here, in the air cathode 25, an air-permeating fluorine resin 26 is coated on one surface of the same, and a carbon 27 is coated on the other surface of the same. The surface coated with the air-permeating fluorine resin 26 is attached to the metal frame 23, and edge portions 28 of the metal frame are folded and compressed toward the air cathode surface coated with the carbon 27. A partition film 29 is attached on the upper side of the surface coated with carbon 27. The metal fuel electrode 22 that is formed in a plate shape is an alloy formed of aluminum and magnesium as major components. The metal frame 23 includes small holes 30 at the edge portions of the same at regular intervals.

The method for fabricating a metal air battery according to the present invention will be described.

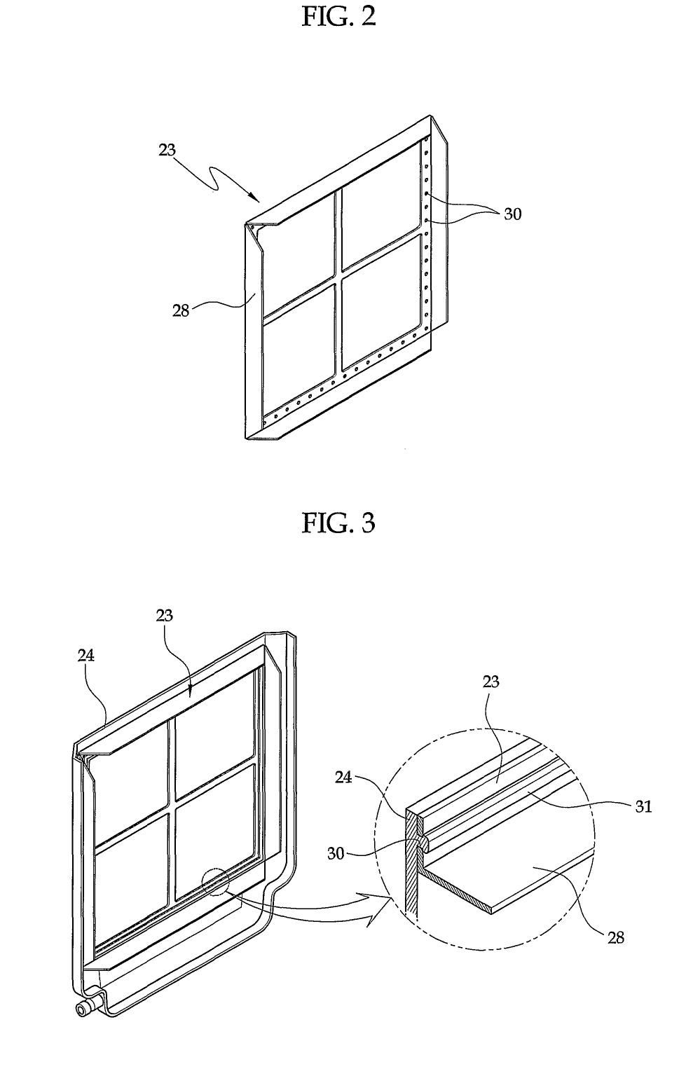

1) Fabrication of the Metal Frame 23—Refer to FIG. 2

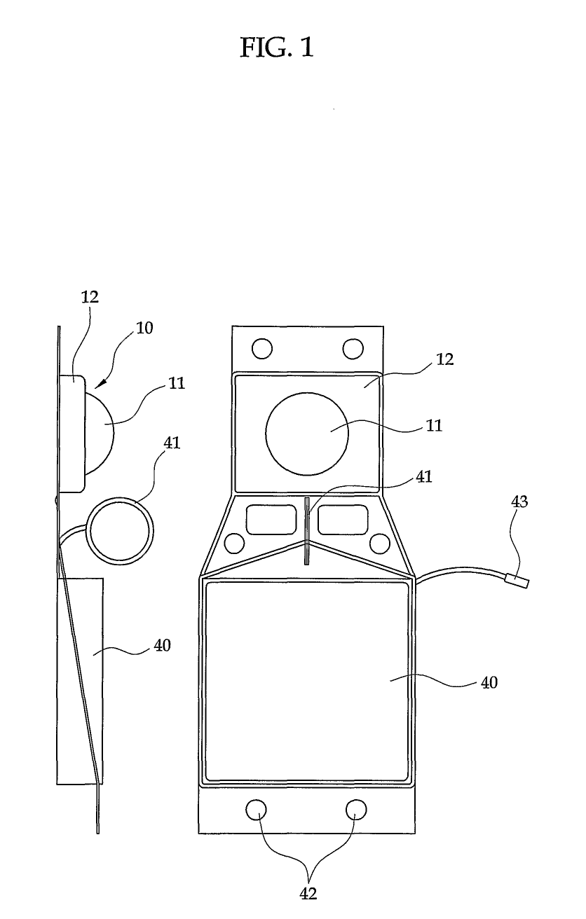

Nickel coated steel plate or nickel plate or stainless steel plate is formed like the construction of FIG. 1 for thereby fabricating a metal frame 23. The metal frame 23 is formed in a cross shape to prevent the distortion of the metal air electrode. A plurality of small holes 30 are formed in edge portions of the metal frame 23 at regular intervals to enhance an adhering force and seal effect with respect to the metal air electrode.

2) Fabrication of Mold—Refer to FIG. 3

After a rubber adhesive is applied to edge portions of the metal frame 23, the metal frame is molded in the metal mold at a temperature of 150˜180° C. under a pressure of 50˜500 kg/cm². The molding of FIG. 3 is obtained. After the rubber molding is performed, rubber strips 31 are formed by the small holes 30 formed on the metal frame 23. Here, the rubber strips 31 perform a sealing function between the metal air electrode and the metal frame after the metal frame 23 is compressed. Here, soft plastic may be used instead of rubber. Since rubber is strongly adhered to a metal surface and has an excellent sealing property, it is one of ideal adhering materials.

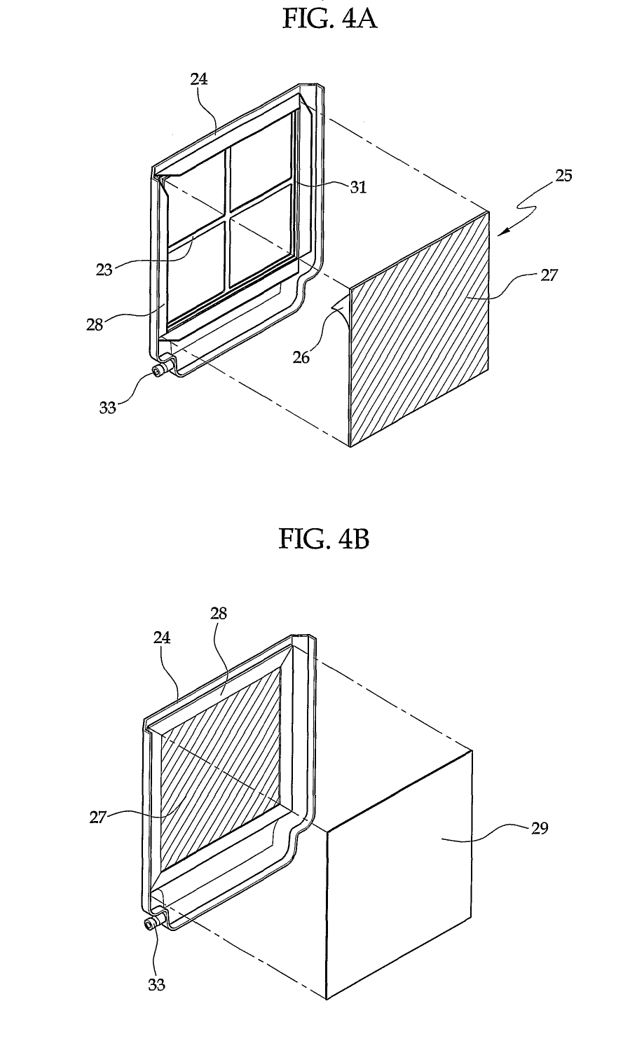

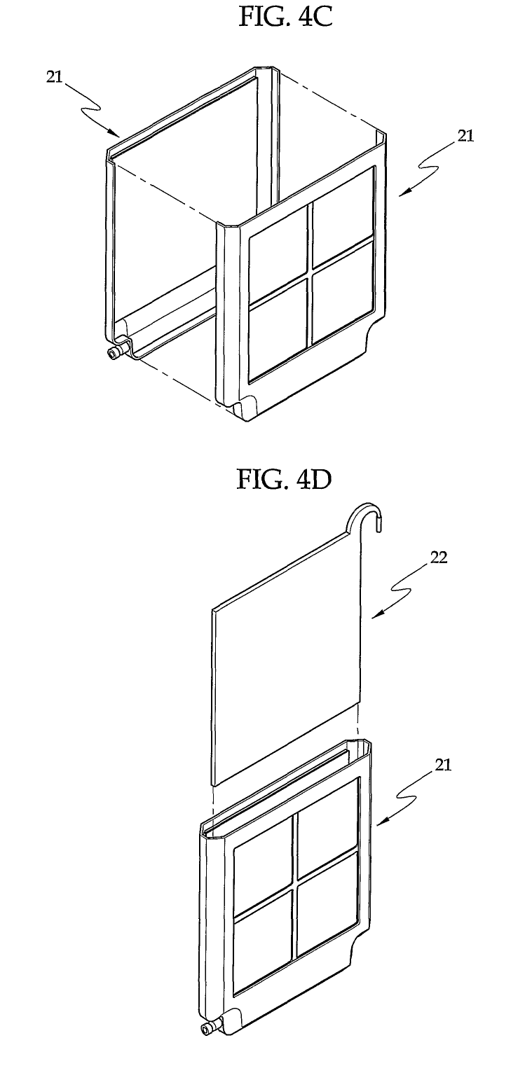

3) Adherence of an Air Cathode (Fabrication of an Air Cathode Assembly)—Refer to FIGS. 4 and 5

An air cathode is adhered to the above fabrication of mold, so that a metal air battery is fabricated. Here, an air-permeating fluorine resin film 26 is coated on one surface of the air cathode, and a carbon film 27 is coated on the other surface of the air cathode. In the air cathode, the surface coated with the air-permeating fluorine resin film 26 is adhered to the metal frame 23, and edge portions 28 of the metal frame is folded and compressed toward the surface coated with the carbon film 27. Since carbon film 27 is strongly adhered to the edge portions 28 of the metal frame, such method of fabrication makes the power produced at the air cathode well transfer to the metal frame. Thereafter, the partition film 29 is adhered to the upper side of the air cathode coated with the carbon film 27. The partition film 29 is a polypropylene non-woven fabric. The partition film 29 prevents inner short circuit between the cathode and the anode, makes the aqueous solution well be absorbed into the partition film. And the partition film 29 prevents fouling of the air cathode 25 by oxide particles generated at the anode. In the description of the present invention, the air cathode fabricated by above method is referred to as an air cathode assembly 21.

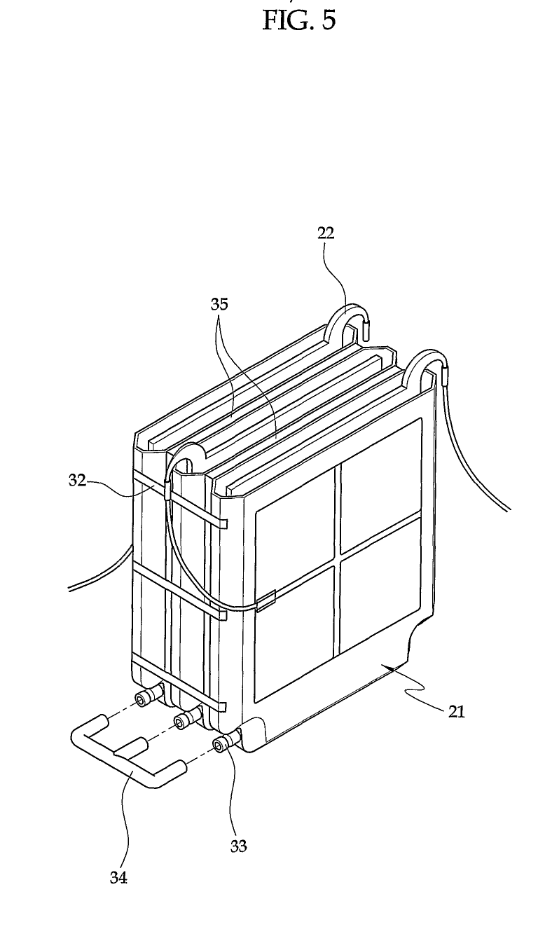

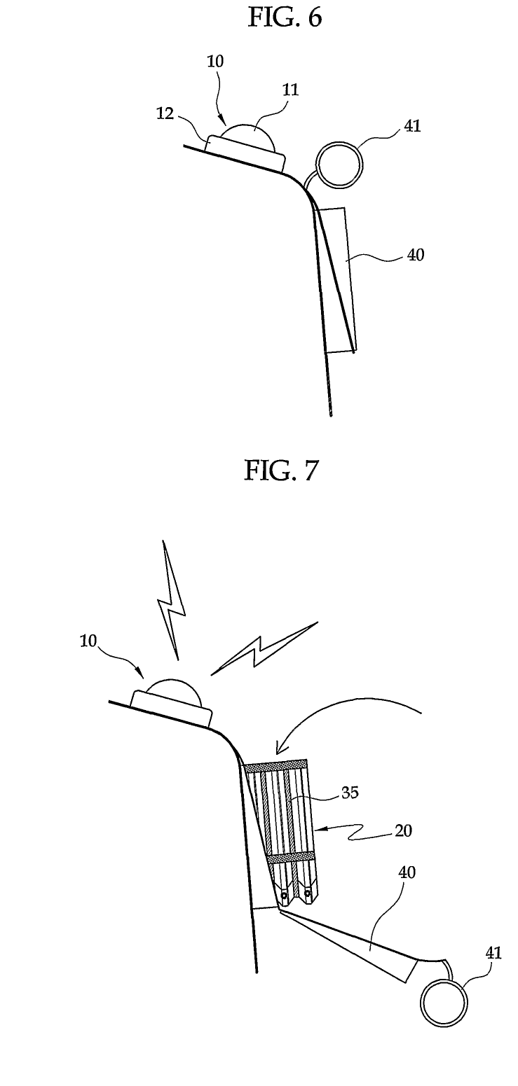

4) Fabrication of Metal Air Electrode—Refer to FIGS. 6 and 7

In the last process, two air cathode assemblies 21 are opposite to each other, and both edge surfaces of two air cathode assemblies are adhered using an adhesive. Thereafter, the metal fuel electrode 22 is inserted between two air cathode assemblies 21. Hereby a metal air battery is fabricated.

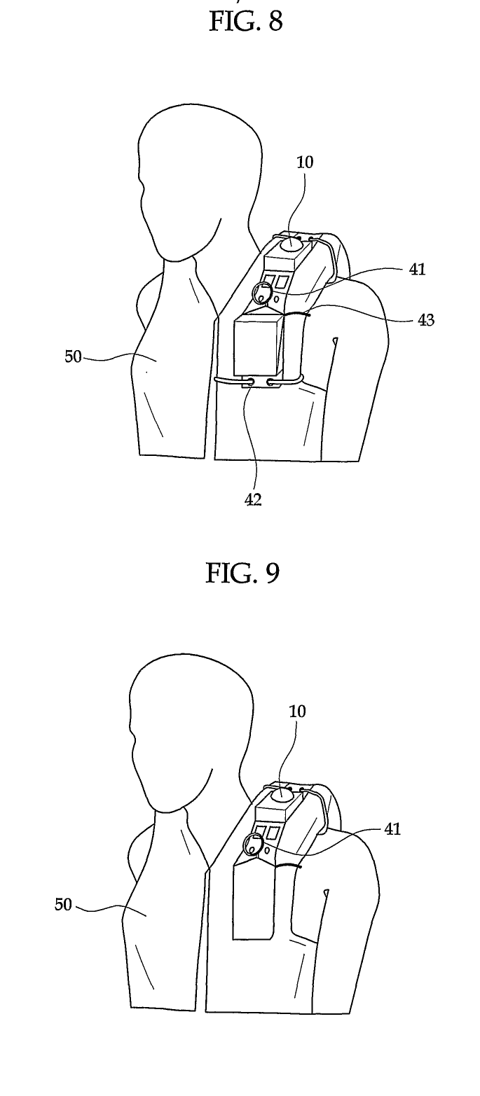

In order to operate a flash lamp for rescue at sea, more than three metal fuel batteries should be connected in series because an input of more than at least 3.0 volts is needed in the circuit. In the case that a plurality of metal fuel batteries are connected, the left, right and lower sides of the air cathode assemblies are adhered with each other using the rubber bands and plastic safety bands 32, and the rubber tube 34 is inserted into the tube hole 33 formed in the lower side of the metal fuel battery (refer to FIG. 8).

Since the structure is formed of a flexible and soft rubber, a certain safety accident like scratch or bruise is prevented, and it is possible to conveniently adhere to a human body. In addition, a plurality of metal fuel batteries are electrically connected using a copper wire. The portions exposed out of the metal frame 23 of the copper wire is weld and connected with the metal anode of the neighboring the air cathode assembly. At this time, a rubber sponge is inserted for an electric insulation between the metal air batteries. Here, the rubber sponge 35 has air holes with apertures of less 80 ppi, so that ventilation and insulation are excellent, and collapsibility is good. The metal air battery 20 uses seawater as electrolyte to make power. However to rescue in river or lake not at sea, a salt pocket 36 may be provided in the interior of the metal air battery 20. The salt pocket 36 is formed of a non-woven fabric so that water penetrates, and salt is provided in the salt pocket 36.

The flash lamp 10 and the metal air battery 20 are packed by an assembled structure 40 formed of flexible plastic film. The assembled structure 40 is fabricated by adhering to two sheets of plastic films. An opening ring 41 is included in the assembled structure 40. Here, the assembled structure 40 is formed of PVC, namely, poly vinyl chloride, so that it is mechanically soft. The assembled structure 40 is achieved by adhering to the edge portions of the plastic films that are well fitted with the spaces of the flash lamp and metal air battery. In the assembled structure 40, the portion enveloping the flash lamp 10 therein is thermally adhered and fully (ideally) sealed. The portion enveloping the metal air battery 20 therein is opened by the user's pulling action so that water and air are introduced. At this time, the portion enveloping the metal air battery 20 therein is thermally adhered or adhered using a water resistant adhesive for thereby achieving a relatively stable fabrication. In such fabricated flash lamp for rescue at sea, the assembled structure 40 is opened only when the user manually pull the opening ring 41. Therefore, the present invention is well adapted to soldiers in a warship (e.g. the navy) and crews at sea. In addition, in the case that the portion enveloping the metal air battery 20 therein is adhered using a water soluble adhesive not a thermal adhering or a water resistant adhesive, when the assembled structure 40 is opened, the compressed air metal batteries 20 are released, and seawater is introduced into the metal-air batteries 20 for thereby generating power. In this case, since an adhesive is water-soluble, it is not needed to pull the opening ring 41. Namely, an adhesive is naturally dissolved after a certain time period is passed, so that the assembled structure 40 is naturally opened.

Since the flash lamp 10 and the metal air battery 20 are connected and are provided in the assembled structure, it is possible to bind the flash lamp according to the present invention to the life jacket, rescue boat or rescue buoy using the strips. Two string holes 42 are provided in the upper, center and lower sides of the assembled structure 40.

Since the metal air batteries are exposed out of the life jacket, a certain groove capable of inserting the metal air batteries may be formed in the life jacket for mariners working actively (FIG. 12). A cover formed of a cloth (woven fabric) covers the portions enveloping the metal air battery therein, so that the acting range of the user is enhanced.

There is provided a stand-by output power terminal 43 as a stand-by power used for the other electronic products. Using the output power terminal, a wrecked person is capable of supplying the power to a cellular phone with a GPS (Global Positioning System) and PDA.

The flash lamp for rescue at sea according to the present invention can be used for a life rescue boat, a life jacket, a buoy, etc. and may be used by soldiers, mariners, etc. for thereby decreasing fatalities.

### Embodiments

As shown in FIG. 2, a nickel frame of a thickness of 0.2 mm and a dimension of 90 mm×90 mm is fabricated using a press, and a silicon rubber adhesive is applied using a brush on edge of the nickel frame and is inserted into a metal mold. A silicon rubber resin is provided and pressed under a pressure of 200 kgf/cm² for one minute at 160° C. After a pair of rubbers is molded, as shown in FIGS. 4, 5, 6 and 7, each air cathode is inserted into the metal frame, and the edge of the metal frame is folded and compressed. A polypropylene non-woven fabric as a partition film is attached, and a pair of air cathode assemblies are adhered using silicon rubber adhesive. Three metal air batteries are fabricated, and a safety band made of a rubber is attached to the lateral surfaces and lower sides, respectively. A metal fuel electrode formed of three-magnesium alloy plates (thickness is 3 mm, and magnesium is 90%, and aluminum is 9%, and zinc is 1%) is inserted into the metal air batteries and connected in series for thereby fabricating a three-cell battery. The voltage generated with the concentration of salt water of 2.5% and 3.5% was less than 4.8 volts, and the maximum voltage was 24 W at NaCl of 2.5%, 27 W at NaCl of 3.5%. And the maximum voltage was 26 W at seawater obtained in a southern seashore area of Korea, and the capacity was 200 Wh in average.

Since the aluminum electrode (aluminum 99%, magnesium 0.5%, and silver 0.5%) outputs lower voltage, four metal air batteries are connected in series and are used. As a result of the power measurement, it was same as the magnesium based batteries.

Injecting silicon rubber into the circuit box and hardening the same improve the mechanical durability and waterproof property of the flash lamp circuit.

The flash lamp circuit consumes an average power of 1˜3 W and outputs light at an interval of about 2˜3 seconds for 100˜200 hours based on an instant flashing. As a result of the measurement performed at seashore in the night, it was possible to visually check at a distance of 10 km. The entire weight of the battery was 290 g in a dry state, and the total weight of the flash lamp and packing structure was about 400 g. It is possible to achieve the same result even when 316 stainless steel plate frames are used instead of nickel plate frames. A mechanical damage was not shown in the batteries and flash lamp under a test environment that seawater waves were simulated.

### INDUSTRIAL APPLICABILITY

As described above, when the user artificially pulls the opening ring or the packing structure is naturally opened, seawater is introduced into the interior of the metal air batteries, so that flash lamp is operated for a long time period. Therefore, the locations of the distressed are effectively located in the night and in a dark environment for thereby achieving an efficient rescue operation. In addition, the battery for flash lamp according to the present invention does not have any oxidizing agent, and the flash lamp is sealed in the assembled structure for thereby greatly extend the shelf life. And an additional maintenance cost is not needed. Since the battery is formed of polymer or rubber film, it is soft and collapsible. Therefore, in the present invention, it does not damage the human body during the rescue operation, and minimizes storing space.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A flash lamp for rescue at sea, comprising: a flash lamp capable of emitting flashlights; a metal air battery that uses seawater as an electrolyte; a circuit that connects the flash lamp and the metal air battery; and an assembled structure that envelops the flash lamp and the metal air battery.

2. The flash lamp of claim 1, wherein said flash lamp emits flashlights using a capacitor circuit.

3. The flash lamp of claim 1, wherein in said metal air battery, a metal fuel electrode is inserted between two air cathode assemblies.

4. The flash lamp of claim 3, wherein a salt pocket is provided in the interior of the metal air battery.

5. The flash lamp of claim 3, wherein said air cathode assembly is fabricated in such a manner that a rubber coat is molded on the metal frame, and an air cathode is attached thereto.

6. The flash lamp of claim 3, wherein said metal fuel electrode that is formed in a plate shape is an alloy formed of major components of aluminum and magnesium.

7. The flash lamp of claim 5, wherein said metal frame comprises a plurality of small holes in edge portions of the metal frame at regular intervals.

8. The flash lamp of claim 5, wherein said air cathode comprises an air permeating fluorine resin coating on one surface of the air cathode, and a carbon coating on the other surface of the air cathode.

9. The flash lamp of claim 8, wherein in said air cathode, a surface coated with the air permeating fluorine resin is adhered to the metal frame, and edge portions of the metal frame are folded and compressed toward the surface coated with carbon, and a partition film is attached on the upper side of the surface coated with carbon.

10. The flash lamp of claim 3, wherein a plurality of metal batteries are fabricated by connecting the left, right and lower sides of the air cathode assembly using rubber bands.

11. The flash lamp of claim 1, wherein said assembled structure is comprises two sheets of plastic films, and an opening ring is included in the assembled structure.

12. The flash lamp of claim 11, wherein in said assembled structure, the portion enveloping the flash lamp therein is fully sealed by thermally adhering.

13. The flash lamp of claim 11, wherein in said assembled structure, the portion enveloping the metal air batteries therein is adhered using a thermal adhering or a water resistant adhesive.

14. The flash lamp of claim 11, wherein in said assembled structure, the portions enveloping the metal air batteries therein is adhered using a water-soluble adhesive.

15. The flash lamp of claim 1, wherein said circuit connected with the flash lamp is molded using silicon rubber for thereby achieving a mechanically enhanced structure.

16. The flash lamp of claim 10, wherein in a plurality of said metal air batteries, a rubber sponge is inserted between metal air batteries.

17. The flash lamp of claim 10, a string hole is formed in an upper, middle and lower side of the assembled structure.

18. The flash lamp of claim 2, wherein said circuit connected with the flash lamp is molded using silicon rubber for thereby achieving a mechanically enhanced structure.
